(19) United States
(12) Patent Application Publication
(10) Pub. No.: US 2017/0074498 A1
(43) Pub. Date: Mar. 16, 2017

(54) Illumination Device

(71) Applicants: Terry Glynn Inscore, Pearland, TX (US); Mark Jason Inscore, Pearland, TX (US)

(72) Inventors: Terry Glynn Inscore, Pearland, TX (US); Mark Jason Inscore, Pearland, TX (US)

(21) Appl. No.: 15/364,161

(22) Filed: Nov. 29, 2016

Related U.S. Application Data
(63) Continuation of application No. 14/608,615, filed on Jan. 29, 2015, now abandoned.

(51) Int. Cl. F21V 23/04; B65D 25/02; F21V 21/08; F21V 19/00; F21S 9/02; F21L 4/02

(52) U.S. Cl. CPC F21V 23/04; F21S 9/02; F21L 4/02; F21V 21/0808; F21V 19/0015; B65D 25/02; B25H 3/02

(57) ABSTRACT

The present application is directed to an illumination device and a method for illuminating one or more target areas. The illumination device includes an electrical switch for activation and deactivation of the device's illumination source. The electrical switch may be operationally configured to form a seal of the device.

### CROSS-REFERENCE TO RELATED APPLICATIONS

This application is a continuation of and claims the benefit of U.S. patent application Ser. No. 14/608,615, filed Jan. 29, 2015, the entirety of which is hereby incorporated by reference herein.

### STATEMENT REGARDING FEDERALLY SPONSORED RESEARCH OR DEVELOPMENT

Not applicable.

### FIELD OF THE APPLICATION

The application relates generally to illumination devices for enclosures and other targeted areas.

### BACKGROUND OF THE APPLICATION

The ability to illuminate enclosures and other targeted areas is known. For enclosure situations, typical illuminating devices are designed for placement along a particular location of an enclosure in order to be activated/deactivated as the cover to the enclosure is opened and closed. In many instances, these illuminating devices fail or result in diminished operating life when exposed to one or more ambient environmental factors. An illuminating device that overcomes the above described shortcomings is desired.

### SUMMARY OF THE APPLICATION

The present application is directed to an illumination device comprising (1) a housing defined by an outer surface, an inner surface and a plurality of openings there through; and (2) electronic components for forming a circuit, the electronic components including at least a power supply, an electrical switch and one or more light sources, the electronic components being mounted to a printed circuit board within the housing and one or more of the electronic components being operationally configured to form seals along one or more of the openings.

The present application is also directed to an illumination device comprising (1) a housing defined by an outer surface, an inner surface and a plurality of openings there through; (2) a circuit formed of electronic components on a circuit substrate, the electronic components including a power source, a contact switch assembly in communication with the power source and disposed through a first opening of the housing, and one or more light sources in communication with the power source, the one or more light sources being located at the remaining openings of the housing; (3) wherein the first opening has a first diameter and the contact switch assembly is operationally configured to seal the outer surface and the inner surface of the housing at the first opening.

The present application is also directed to a method for illuminating a cover bearing container, the method comprising (1) determining the size of the container and the one or more locations within the container to illuminate when the container cover is in an open position; (2) providing an illumination device including (a) a housing defined by an outer surface, an inner surface and a plurality of openings there through, the location of the openings along the housing being placed according to the size of the container and the one or more locations within the container to illuminate; and (b) electronic components for forming a circuit, the electronic components including at least a power supply, an electrical switch assembly and one or more light sources, the electronic components being mounted to a printed circuit board within the housing and one or more of the electronic components being operationally configured to form seals along one or more of the openings, the type of the one or more light sources used being determined according to the size of the container and the one or more locations within the container to illuminate; (3) adhering the illumination device to an inner surface of the container via an attachment member in a manner effective for the container cover to contact the electrical switch assembly when the cover is set to a closed position.

### BRIEF DESCRIPTION OF THE SEVERAL VIEWS OF THE DRAWINGS

FIG. 1 is a perspective view of an embodiment of an illuminating device of the application.

FIG. 2 is another perspective view of an illuminating device of the application.

FIG. 3 is another perspective view of an illuminating device of the application.

FIG. 4 is an exploded view of an embodiment of an illuminating device.

FIG. 5A is a side view of an exemplary illuminating device and a target surface for attachment of the device thereto.

FIG. 5B is a phantom view of the device of FIG. 5A illustrating a simplified mating surface between the device and the target surface.

FIG. 6 is a side view of another embodiment of an illuminating device and a target surface for attachment of the device thereto.

FIG. 7 is a simplified exploded view of a partial electrical switch and an actuator cover.

FIG. 8 is a simplified view of an actuator cover in a sealable position with an outer surface of a housing of an illuminating device of this application.

FIG. 9 is a simplified view of an actuator cover in a sealable position with an inner surface of a housing of an illuminating device of this application.

FIG. 10 is a perspective phantom view of an embodiment of an illuminating device of this application.

FIG. 11 is a simplified sectional view of a light emitting diode in abutment with an opening through a housing of an illuminating device of this application.

FIG. 12 is a perspective phantom view of an open lid container including an illuminating device attached to the inner surface of the container in an ON position illuminating the container.

FIG. 13 is a perspective phantom view of a closed lid container including an illuminating device attached to the inner surface of the container in an OFF position.

FIG. 14 is a perspective view of a tool box including an illuminating device attached to the inner surface of the tool box in an ON position illuminating the tool box.

FIG. 15 is a simplified circuit diagram of an electrical circuit of the illuminating device.

FIG. 16 is another simplified circuit diagram of an electrical circuit of the illuminating device.

### DETAILED DESCRIPTION

Before describing the invention in detail, it is to be understood that the present system, device and method are not limited to particular embodiments. It is also to be understood that the terminology used herein is for the purpose of describing particular embodiments only, and is not intended to be limiting. As used in this specification and the appended claims, the phrase “target surface” refers to a contact surface for the device discussed herein during device operation. Herein, the term “enclosure” may refer to an area that is sealed off with an artificial barrier such as a cover. A “cover” for an enclosure may include a door, lid, cap, flap, sheet, or barrier forming structure for sealing off an open portion of an enclosure. As used herein and for purposes of the present disclosure, the term “LED” or “light emitting diode” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (“OLEDs”), electroluminescent strips, and the like. Herein, a “seal” may refer to a fluid seal, a solids seals, or both a fluid and solids seal.

In one aspect, the application provides a waterproof illuminating device for use with enclosures whereby the enclosure is illuminated once the cover to the enclosure is lifted or otherwise removed from the enclosed position.

In another aspect, the application provides an adaptable illuminating device operationally configured to be releasably secured to a plurality of surfaces.

In another aspect, the application provides an illuminating device that may be releasably secured to both external surfaces and internal surfaces of an enclosure.

In another aspect, the application provides an illuminating device that may be operationally configured to abut one or more target surfaces in a fixed position.

In another aspect, the application provides an illumination device including a power source and an electrical switch in communication thereto, the switch being operationally configured to provide one or more seals along an outer surface and an inner surface of the housing of the illumination device.

In another aspect, the application provides an illumination device including a power source and an electrical switch assembly in communication thereto, the electrical switch assembly being operationally configured to provide one or more seals along an outer surface and an inner surface of the illumination device.

In another aspect, the application provides an illumination device including a housing and electronic components therein. The electronic components including an electrical switch operationally configured to provide one or more seals along an outer surface and an inner surface of an opening through the housing.

In another aspect, the application provides an illumination device operationally configured to operate with a retractable device such as a drawer, e.g., cabinet drawer, and the like.

In another aspect, the application provides an illumination device including a linear switch operationally configured for linear movement to operate with a retractable device such as a drawer, e.g., cabinet drawer, and the like, contacting the linear switch from one or more angles as desired.

In another aspect, the application provides an illumination device operationally configured to be placed at varying distances from a cover of an enclosure or otherwise adjusted as desired for operation.

In another aspect, the application provides an illumination device operationally configured to emit light in one or more directions.

In another aspect, the application provides an illuminating device including an electrical switch operationally configured to provide one or more seals along the perimeter of an opening of the housing of the electrical switch.

In another aspect, the application provides an illuminating device including an electrical switch having a spring biased actuator member and an actuator member cover defined by one or more sealing members.

In another aspect, the application provides an illuminating device including an electrical switch having a spring biased actuator member and an actuator member cover defined by one or more sealing members wherein the one or more sealing members are operationally configured to provide a seal with the outer surface and the inner surface of the housing of the electrical switch along the perimeter of an opening of the electrical switch.

In another aspect, the application provides an illuminating device including a contact switch assembly operationally configured to dictate the on/off position of the one or more light sources of the device.

In another aspect, the application provides an illuminating device including a housing with at least one opening in the form of a recessed hole operationally configured to abut a light source of the device at a point below the outer surface of the housing.

In another aspect, the application provides an illuminating device including a housing in the form of two parts, each part having side walls with cutout portions effective to form one or more openings when the parts are joined together.

In another aspect, the application provides an illuminating device including a housing in the form of two parts, each part having side walls with cutout portions effective to form one or more openings when the parts are joined together, and an electrical switch having a spring biased actuator member extending out through an opening formed by the cutout portions.

To better understand the novelty of the system, device and method of use thereof, reference is hereafter made to the accompanying drawings. Generally, the application provides an illumination device that may be automatically actuated by the manipulation of one or more of the device's electronic components. In one particular embodiment, the device of this application provides a light source, i.e., illumination source, for an enclosure, the device being automatically actuated by the opening and closing of the cover of an enclosure whereby one or more light sources are set to an “ON” position when the cover is open or removed and to an “OFF” position when the enclosure is closed or when a cover otherwise seals the enclosure. In one suitable embodiment, the various component parts of the device are effective to provide a fluid sealable device. In another suitable embodiment, the device is operationally configured to be fixed to one or more target surfaces and oriented thereon as desired. It is further contemplated that the illumination device of this application may be built to scale and is not necessarily limited to any particular light intensity or wavelength so that the device may emit light ranging from about 350 nm to about 900 nm.

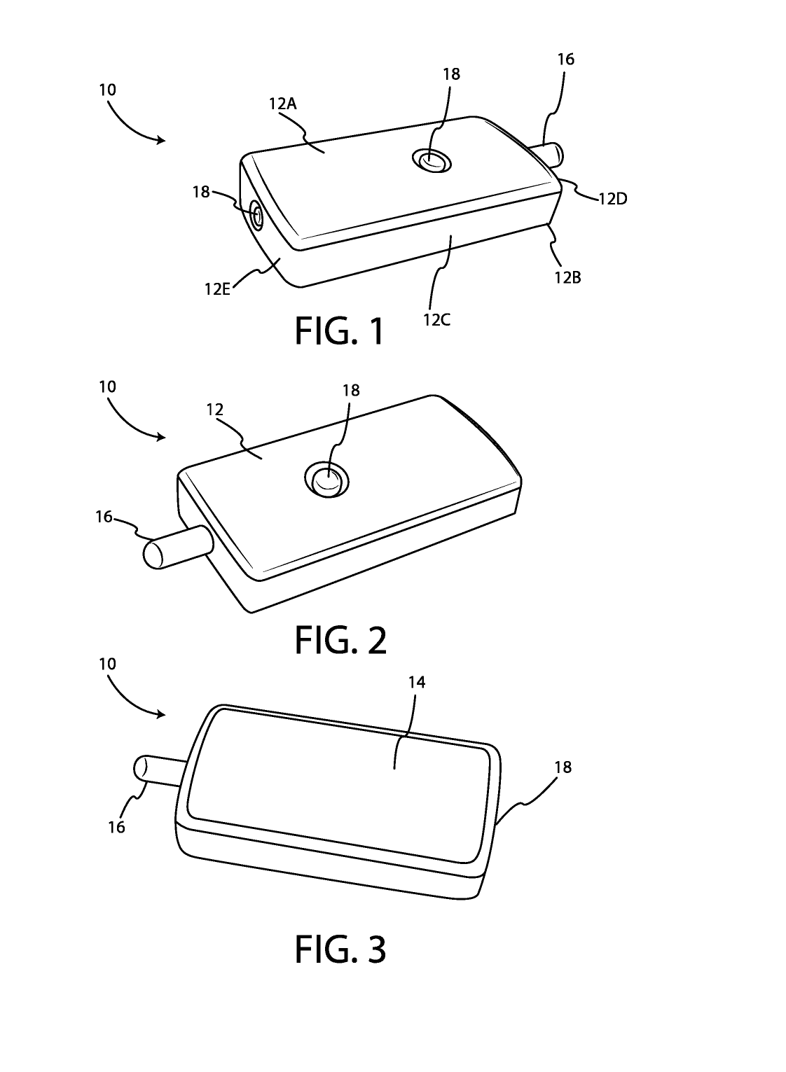

With attention to FIGS. 1-4, the device 10 suitably includes an outer housing 12 effective as an enclosure for one or more electronic components. Suitably, the housing 12 includes one or more openings there through for exposing or otherwise communicating various electronic components with the ambient environment external the housing 12. The electronic components of the device 10 may include, but are not necessarily limited to electronic components in electrical communication, for example, a power source 15, an electrical switch 16 and one or more light sources 18 within the housing 12. Suitably, one or more of the electronic components are operationally configured to communicate with the one or more openings of the housing 12 as described more below.

Although the device 10 of this application may be configured as desired, one suitable device 10 includes an outer housing 12 having a substantially rectangular box like shape defined by (1) an outer surface or visible surface 12A, (2) a mounting surface 12B, (3) side walls 12C and (4) opposing ends 12D and 12E (see FIG. 1). In addition, the housing 12 may include at least one attachment member 14 along the mounting surface 12B (FIG. 3) for permanently or releasably securing the device 10 to a target surface. Suitable attachment members 14 may include, but are not necessarily limited to hook and loop fasteners, one or more adhesive materials, magnets, pop-in male type fasteners, snaps, catches, threaded female-type receivers, pop-in female-type receivers, and combinations thereof. In another embodiment it is contemplated that the device 10 be provided with an appendage or separate attachment piece including one or more of the above type attachment members operationally configured for securing the device 10 to one or more target surfaces. Suitably, the attachment member 14 is operationally configured to adhere or otherwise be secured to one or more materials typically used in enclosure construction, e.g., woods, glass, polymeric materials, metals, textiles, composite materials, and combinations thereof. In addition, the attachment member 14 is operationally configured to adhere or otherwise be secured to these one or more materials in a non-destructive manner.

Referring to FIG. 3, one suitable attachment member 14 may include an adhesive article attachable to the surface of two substrates as understood by the skilled artisan. The type of adhesive article employed is not necessarily limited to any particular kind, however, a suitable adhesive article for any one particular operation may be determined according to (1) one or more surface conditions including, but not necessarily limited to roughness, smoothness, porosity, coated, uncoated, cleanliness, flexibility, (2) size of the target surface, (3) size of the device 10, (4) materials of construction of the target surface, (5) surface energy of the device 10, and combinations thereof. In one embodiment, the adhesive article may include a two sided adhesive tape with an outer removable film or release liner for covering the adhesive tape until usage. In operation, an adhesive article may be adhered to the mounting surface 12B without altering the basic surface configuration of the mounting surface 12B. Thereafter, the mounting surface 12B may be set in abutment with a target surface at a desired location, e.g., at a particular position on an enclosure side wall. Without limiting the invention, one suitable adhesive tape includes double sided or twin stick industrial tape. Another suitable adhesive tape may include double sided or twin stick adhesive foam tape. In another embodiment, the attachment member 14 may include a magnet with an adhesive backing. In another embodiment, the attachment member 14 may include adhesive putty. In one suitable embodiment including a device 10 incorporating adhesive tape, the device 10 may be removably secured to one or more target surfaces as desired making the device 10 mobile and versatile.

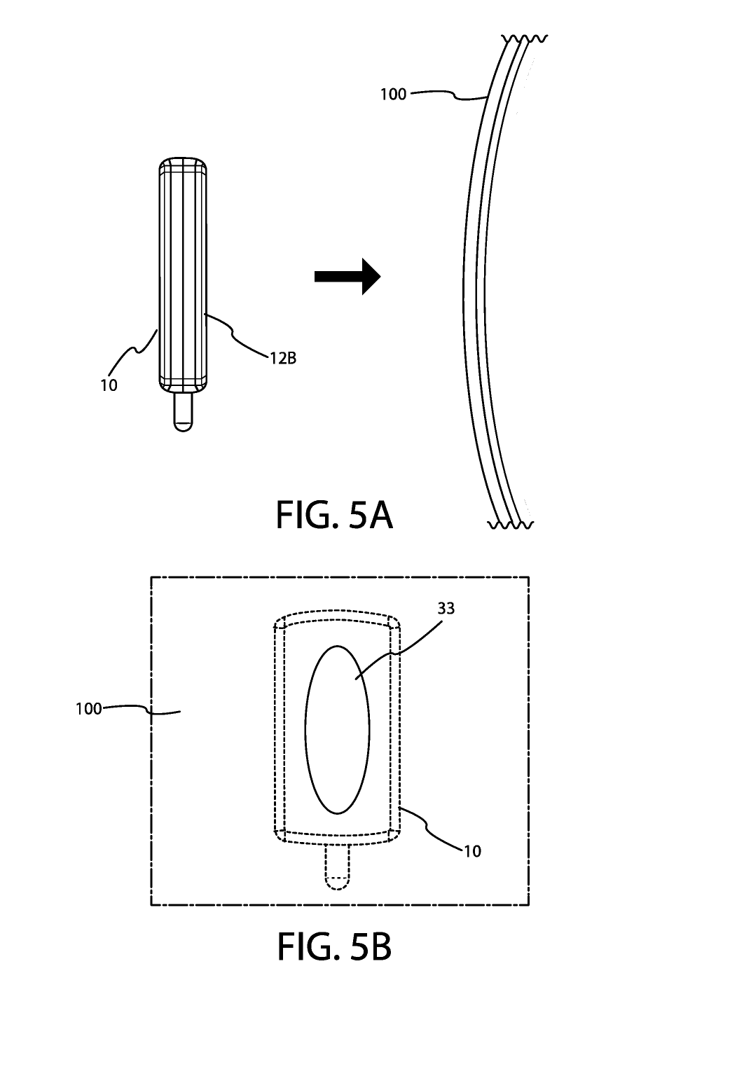

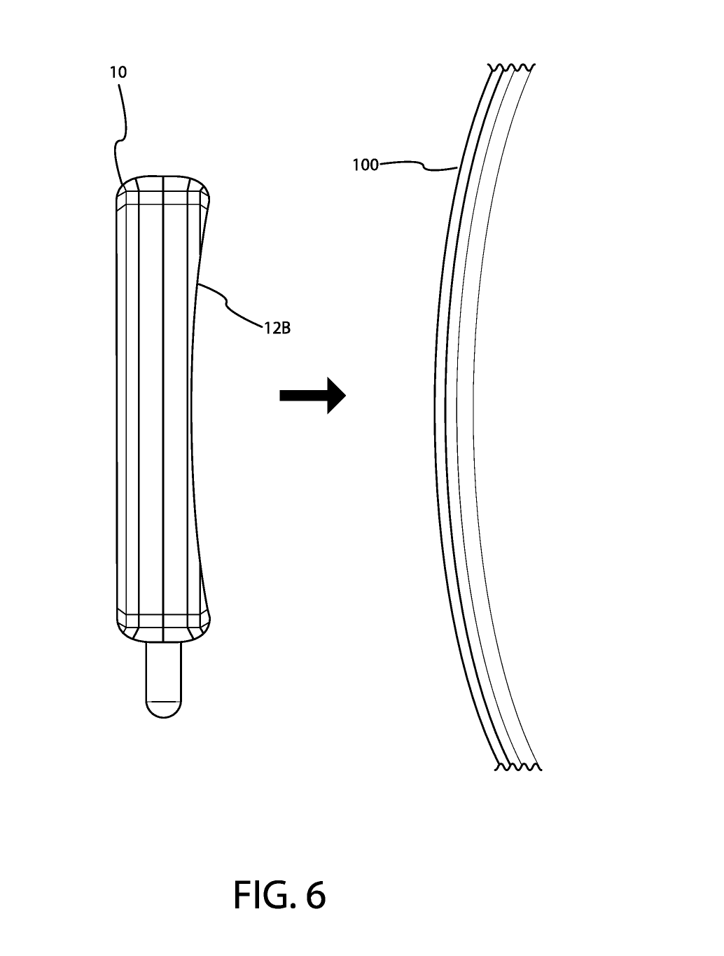

The mounting surface 12B may include an outer surface configuration similar to the surface configuration of one or more target surfaces, e.g., substantially flat corresponding surfaces. As an example, an attachment member 14 in the form of an adhesive article may be provided as a substantially planar member for adhering to a substantially planar mounting surface 12B as shown in FIG. 3. In another embodiment, an adhesive article may be constructed in a non-planar form, e.g., an irregular surface shape and/or a surface defined by one or more raised patterns or surface areas. In the embodiment as depicted in FIG. 3, the surface configuration of the mounting surface 12B and/or adhesive article is/are suitably effective to provide a desired abutment surface area with a desired surface area of a target surface. For example, where the device 10 includes a substantially planar mounting surface 12B and a substantially planar adhesive article attached thereto, a substantially planar target surface may receive up to about 100.0 percent of the surface area of the adhesive article in abutment there with. Where the same device 10 is used on an outwardly curving target surface 100, the target surface may receive less than 100.0 percent of the surface area of the adhesive article in abutment thereto and still maintain the device 10 in a fixed position against the target surface 100 (see “mating surface” 33 as depicted in the simplified illustrations of FIGS. 5A and 5B, which depicts about half of the adhesive article in abutment with a target surface 100). In another embodiment where a target surface 100 includes an outwardly curving surface, the device 10 may include a curved mounting surface 12B for abutment of up to about 100.0 percent of the mounting surface 12B and adhesive article adhered thereto with the target surface 100 (see FIG. 6). In an embodiment where a target surface 100 includes a non-planar surface, the device 10 may include a substantially planar mounting surface 12B and an adhesive article operationally configured to abut a desired surface area of the target surface effective to maintain the device 10 in a fixed position during operation. Likewise, in an embodiment where a target surface 100 includes a substantially planar surface, the device 10 may include a non-planar mounting surface 12B and an adhesive article operationally configured to abut a desired surface area of the target surface 100 effective to maintain the device 10 in a fixed position during operation.

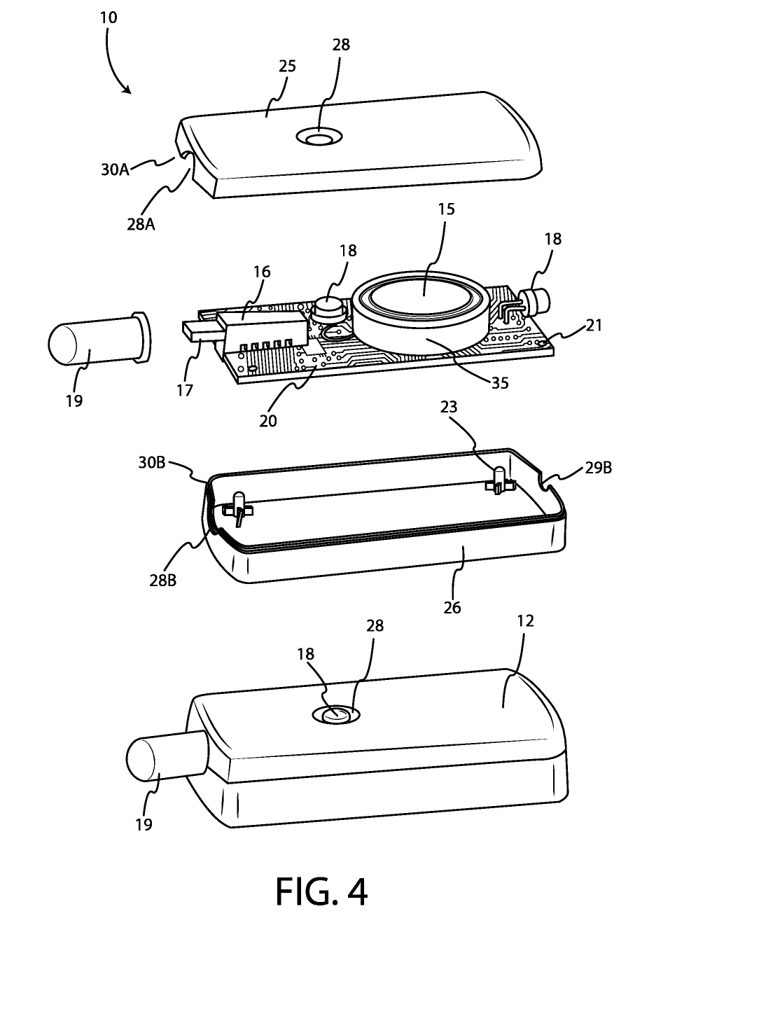

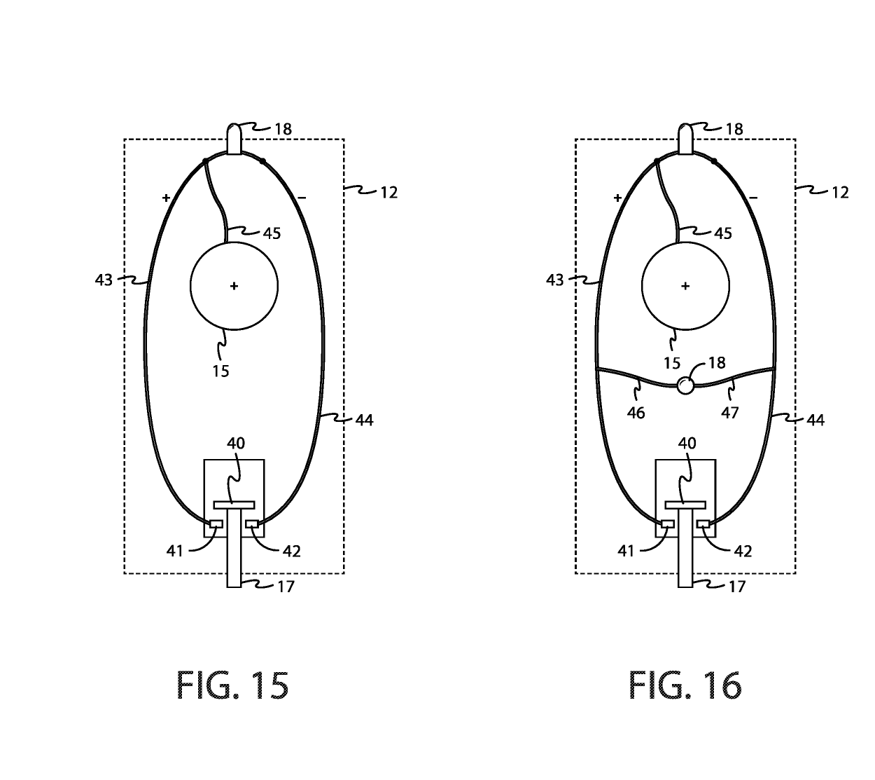

With attention to FIG. 4, the housing 12 is operationally configured to hold electronic components for forming a circuit on a circuit substrate. The electronic components include at least (1) a power supply 15 in the circuit, (2) an electrical switch 16 in the circuit and (3) one or more light sources 18 in the circuit—each of which is mounted to (4) a printed circuit board 20 operationally configured to receive the components in attachment thereto as understood by the skilled artisan—see also FIGS. 15 and 16.

In the embodiment as shown, the housing 12 is suitably a two part member operationally configured to be mated together to enclose or envelope the printed circuit board 20 (“PCB”) and electronic components attached thereto. A first part or first housing member 25 suitably includes a box type configuration with a base and side wall(s) operationally configured to cover the component side of a PCB 20. A second part or second housing member 26 also includes a similar box type configuration operationally configured to (1) cover the opposite side of the PCB 20 and (2) secure the PCB 20 thereto in a fixed position. As shown, the inner surface of the second housing member 26 may include one or more male type fasteners 23 operationally configured to mate with apertures 21 disposed along the PCB 20 for holding the PCB 20 in a fixed position during device 10 operation.

Stiff referring to FIG. 4, the side walls of the first and second housing members 25, 26 are provided with connection surfaces 30A, 30B along their perimeter edges effective for forming a housing 12 for the one or more electronic components. In one embodiment, the connection surfaces 30A, 30B may include flat surfaces for abutment there between including the use of one or more adhesive materials for maintaining the first and second housing members 25, 26 in a secured position. In another embodiment, the connection surfaces 30A, 30B may include tongue and groove type surfaces. As shown in FIG. 4, the connection surfaces 30A, 30B may include stepped configurations or other offset surfaces effective for increasing the surface area of the connection surfaces 30A, 30B effective for forming a seal there between. One or more sealants may be employed as desired for forming a fluid and/or solids seal between the connection surfaces 30A and 30B. Suitable sealants include, but are not necessarily limited to one or more resin materials such as epoxy resin and silicon resin, and plastic bonding adhesives.

As stated above, the housing 12 includes one or more openings there through for exposing or otherwise communicating various electronic components with the ambient environment external the housing 12. For example, the first housing member 25 may include one or more openings 28 effective for the emission of light originating from the one or more light sources 18 secured to the PCB 20 within the housing 12. In one embodiment, the one or more openings 28 may be provided as common open through holes in the first housing member 25 effective for the emission of light generally. In another embodiment, the one or more openings 28 may correspond in location with one or more light sources 18 as shown in FIG. 4. As further shown in FIG. 4, each of the one or more openings 28 are suitably provided in a size and shape to accommodate particular light sources 18, e.g., a circular opening 28 for receiving at least part of a circular light source 18 there through. In one embodiment, the light source 18 may rise out from the outer surface of the first housing member 25. In another embodiment, the outer most portion of a light source 18 may lie substantially flush with the outer surface of the first housing member 25. As shown in FIG. 4, an opening 28 may also be provided as a recessed hole in the first housing member 25 with an opening effective to abut, stop or catch a light source 18 at a point below the outer surface of the first housing member 25. As further shown in FIG. 4, the one or more openings 28 may be provided as countersunk holes. In another embodiment, the one or more openings 28 may be provided as counterbored holes.

Still referring to FIG. 4, the distal edges of the first and second housing members 25, 26 may include one or more cutout portions (see 28A, 28B, 29B) in the side walls effective to form openings 28 along the distal edges of the side walls of the housing 12 when the first and second housing members 25, 26 are joined together during device 10 operation. The cutout portions may include any desired shape, e.g., curved shaped, cornered edges, and combinations thereof to accommodate one or more electronic components. In one suitable embodiment, the cutout portions may each be provided as semi-circle type cutouts in the distal edges of the first and second housing members 25, 26 whereby corresponding cutout portions form circular openings 28 when the first and second housing members 25, 26 are mated together to form the housing 12.

The housing 12 is suitably constructed of one or more materials durable enough to maintain its basic shape and prevent the passage of fluid(s) and/or solids there through. In particular, the housing 12 may be constructed of one or more materials including but not necessarily limited to those materials resistant to chipping, cracking, excessive bending and reshaping as a result of ozone, weathering, heat, moisture, other outside mechanical and chemical influences, as well as various impacts and other loads placed on the housing 12. Likewise, the housing 12 may comprise any color or combination of colors, or in the alternative, the housing 12 may be transparent and translucent depending on individual preferences and needs.

Suitable housing 12 materials include, but are not necessarily limited to metals, plastics, rubbers, woods, fiberglass, plexiglass, filled composite materials, and combinations thereof. Suitable plastics include, but are not necessarily limited to (1) thermoplastic polymers, for example, acrylonitrile butadiene styrene (ABS), polyvinyl chloride (PVC), polyamide (Nylon), polymethyl methacrylate (Acrylic), polypropylene, polystyrene, low density polythene (LDPE), high density polythene (HDPE); and (2) thermosetting polymers, for example, silicone and urea formaldehyde. Suitably metals include, but are not necessarily limited to aluminum, steel, titanium, and combinations thereof. In one suitable embodiment, the housing 12 may be provided as an injection mold plastic member. In another embodiment, the housing 12 may be comprised of PVC. In another suitable embodiment, the housing 12 may be comprised of vinyl polymer. In another suitable embodiment, the housing 12 may be comprised of aluminum.

As understood by the skilled artisan, the electronic components of the device 10 form a circuit to provide an ON/OFF device 10 effective for emitting light under one or more conditions. As stated above, the electronic components suitably include at least (1) a power supply 15, (2) an electrical switch 16 or switch assembly and (3) one or more light sources 18 each of which is mounted to (4) a PCB 20. As shown in FIG. 4, a suitable electrical switch assembly 16 includes a contact switch assembly having a spring biased actuator member 17 that may be directed linearly to a depressed position to open the circuit and directed outward to close the circuit—dictating the ON/OFF position of the one or more light sources 18. As understood by the skilled artisan, the power supply 15 is effective to provide an interruptible supply of power to the one or more light sources 18. In other words, the electrical switch 16 permits power from the power supply 15 to illuminate the one or more light sources 18 when the actuator member 17 is extended out in a non-depressed position and interrupts the supply of power to the one or more light sources 18 when the actuator member 17 is depressed. With attention to the simplified illustrations of FIGS. 15 and 16, when the actuator member 17 is in a depressed position, the contacts (40, 41 and 42) are separated and the circuit is open. When the actuator member 17 is biased outward, a connection is formed between contact 40 and contacts 41 and 42 closing the circuit and activating the light source(s) 18—see wires 43-45 in FIG. 15 and wires 43-47 in FIG. 16.

In operation, the actuator member 17 is operationally configured to extend out through a corresponding opening 28 of the housing 12 whereby it can be acted on by one or more forces external to the device 10. In the embodiment of FIG. 4, the actuator member 17 suitably extends out through an opening 28 along a distal edge of the first and second housing members 25, 26 at 28A and 28B although other contact switch configurations are herein contemplated.

The actuator member 17 may further include an actuator member cover 19 or “actuator cover” or “cover” operationally configured to protect the actuator member 17 from direct contact and/or provide fluid seals and/or solids seals with the outer surface and/or the inner surface of the housing 12 along the perimeter of the opening 28 of the actuator member 17, e.g., at the opening formed by 28A and 28B in FIG. 4. One suitable cover 19 is defined by a longitudinal axis and has an open hollow member at one end that may be slipped onto the actuator member 17 in a snug type fashion effective to direct the actuator member 17 therein linearly between a depressed position and an extended or non-depressed position. In operation, the spring of the switch assembly 16 biases the actuator member 17 outward to an extended resting position. Once an external force greater than the biasing force of the spring is placed on the cover 19 the actuator member 17 and cover 19 may be directed inward toward the housing 12 to a depressed open position of the circuit (turning off the one or more light sources 18).

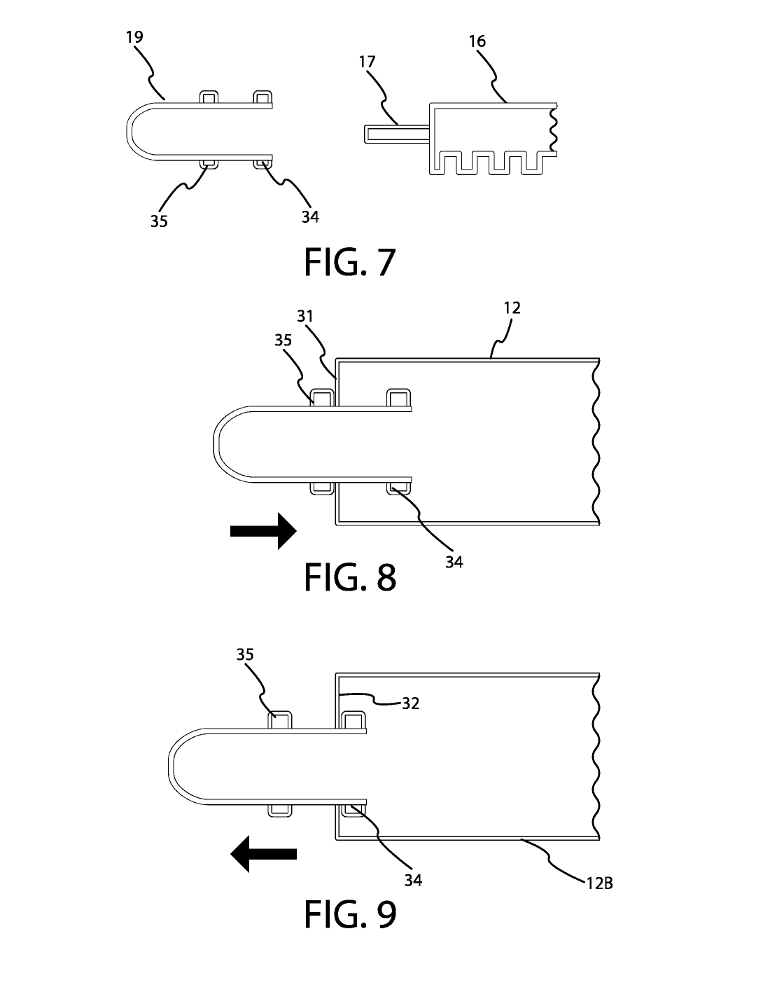

As shown in FIG. 4, the cover 19 may include an opening defined by one or more sealing members provided as an enlarged perimeter or collar type member. Turning to FIG. 7, a cover 19 may include two sealing members provided as collar members 34, 35, each collar member comprising a diameter (or width) greater than the diameter (or width) of the corresponding opening 28 in a manner effective to provide fluid and/or solids seals with the outer surface and/or the inner surface of the housing 12 along the perimeter of the opening 28. The collar members 34, 35 are not necessarily limited to a particular diameter (or width), but suitable collar members 34, 35 may have a diameter (or width) up to about 25.0 percent greater than the diameter (or width) of the cover 19.

In addition, the cover 19 may be constructed from one or more resilient materials effective to form a seal with the inner perimeter surface of the opening 28 while allowing the cover 19 to travel linearly through the opening 28 during device 10 operation. The cover 19 may also be adjustable along the length of the actuator member 17 thereby adjusting the overall length of the actuator member 17 for activation/deactivation purposes of the device 10 as desired or otherwise required for one or more particular uses.

With attention to FIGS. 8 and 9, collar member 34 is suitably located along the cover 19 at a point internal the housing 12 and collar member 35 is located along the cover 19 at a point external the housing 12 when the device 10 is assembled. As shown in the simplified illustration of FIG. 8, when the actuator member 17 is set to a depressed open position of the circuit, collar member 35 sealably abuts the outer surface 31 of the housing 12. When the actuator member 17 is directed outward toward a non-depressed closed position of the circuit, the seal formed between the collar member 35 and the outer surface 31 discontinues and a seal is formed between the collar member 34 and the inner surface 32 once the collar member 34 abuts the inner surface 32.

As shown, the cover 19 shown in FIGS. 7-9 includes a dome type distal end, but other configurations are also contemplated. For example, the distal end of the cover 19 may include a flat configuration or a concave configuration. It is also contemplated that the cover 19 may be operationally configured to receive an external force having a vector direction non-linear the longitudinal axis of the cover 19. For example, the cover 19 may include a ball shaped distal end, a rounded shoulder distal end, or a mushroom shaped distal end effective to direct the actuator member 17 to a depressed open position of the circuit when contacted by an object moving along a vector up to about perpendicular the longitudinal axis of the cover 19.

In another embodiment, the collar members 34, 35 may include tacky surfaces for enhancing the sealability of the device 10. In still another embodiment for enhancing sealability of the device 10, the collar member 34, 35 may include raised surfaces and the outer surface 31 and inner surface 32 of the housing 12 may include cavities or depressed mating regions for receiving the raised surfaces in abutment thereto.

Referring again to the embodiment of FIG. 4, the power supply 15 suitably includes one or more batteries secured to the PCB 20. In this embodiment, the PCB 20 includes a raised compartment 35 effective for holding one or more batteries therein. In practice, the size and shape of the compartment 35 may be determined according to the size and shape of one or more batteries 15 employed. For example, the exemplary compartment 35 of FIG. 4 may include a depth therein suitable for holding up to two stacked button or coin type batteries as such terms are commonly known in the art. Without limiting the type of battery 15 of this application, suitable button or coin type batteries include, but are not necessarily limited to lithium, lithium-ion, silver-oxide, nickel zinc, and combinations thereof. The type and quantity of batteries 15 employed may be determined according to the type and/or quantity of light sources 18 used as well as the desired life span of the device 10 In an embodiment like the one of FIG. 4, two batteries will approximately double the life span of the device 10 compared to a single battery device 10.

Although the device 10 may be built to scale and require one or more particular types of power supplies 15, suitable devices 10 for use with common enclosures may include button type batteries 15 with dimensions ranging from about 4.0 mm to about 15.0 mm in diameter and a thickness ranging from about 1.5 mm to about 5.0 mm. In addition, the configuration of the compartment 35 may be designed to hold as many batteries 15 as desired or otherwise required, e.g., one battery, four batteries, etc. Examples of common enclosures include, but are not necessarily limited to storage boxes, tool boxes, ice chests, fuse boxes or circuit breaker boxes, junction boxes, medicine cabinets, bread boxes, closets, drawers, cabinetry, storage chests or furniture chests, jewelry boxes, file cabinets, refrigerators, freezers, tackle boxes, attics, safes, humidors, mailboxes or letter boxes, post office boxes, safe deposit boxes, shipping containers, shipping boxes, storage rooms, vehicle interiors or cockpits for work tractors, automobiles, planes, helicopters and boats, automobile trunks and/or glove compartments, aquariums, garages, basements, storm cellars, office and/or living rooms, suitcases, briefcases, ammunition boxes, first aid boxes, lunch boxes, rodent traps, barrels and/or drums, overhead bins, motorcycle trailers and/or trunks and/or saddlebags, and combinations thereof.

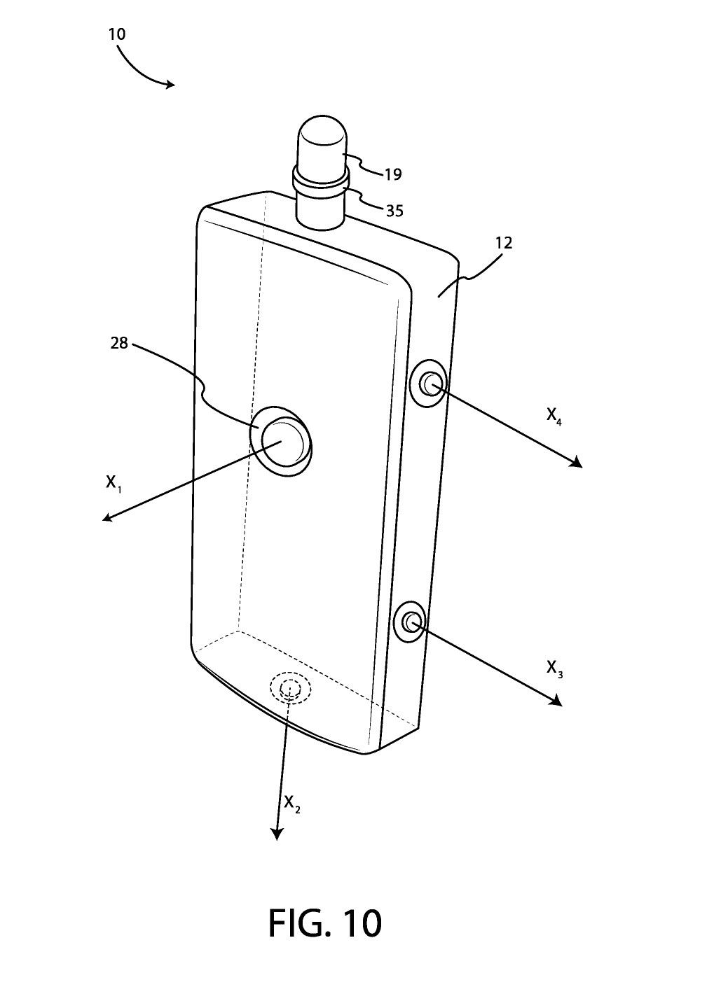

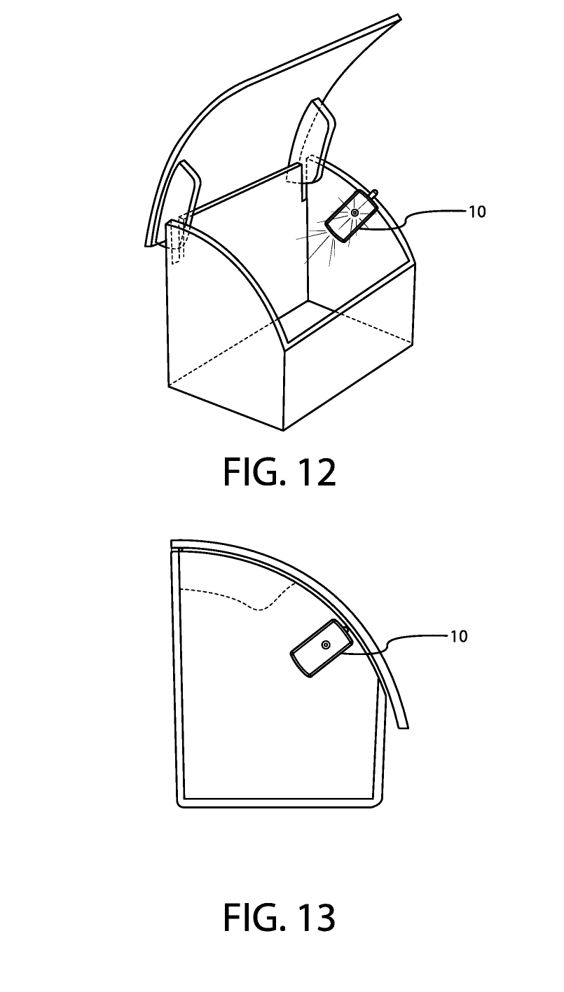

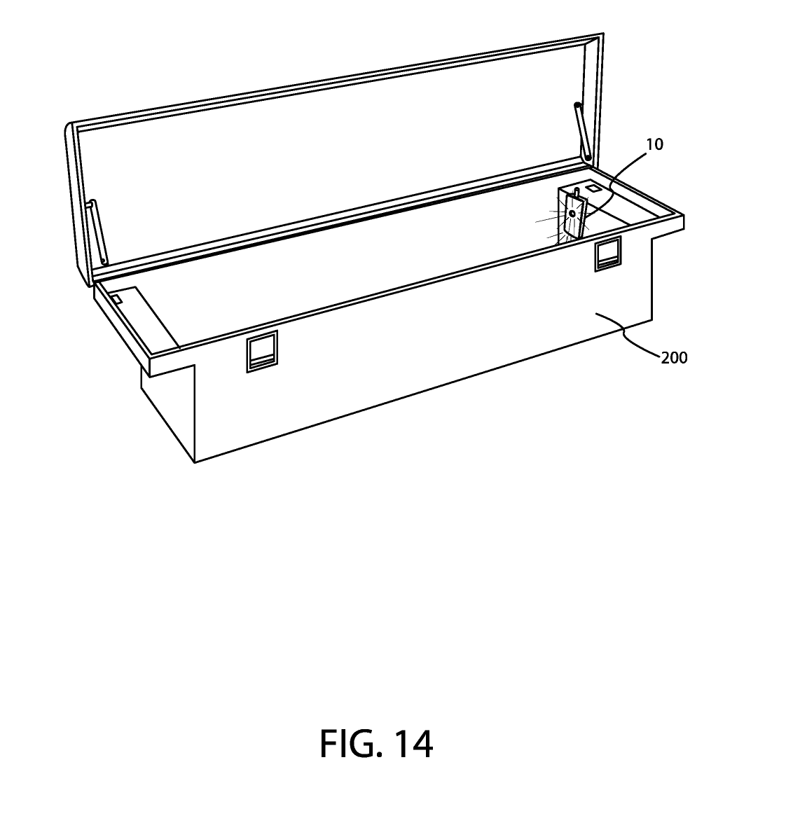

In operation, the one or more light sources 18 are operationally configured to illuminate a target space or area. As such, the device 10 may include a light source array designed to illuminate light in one or more directions as desired. In other words, the housing 12 may include openings 28 at one mores locations allowing for the focusing of light in one or more particular directions—see the simplified illustration of FIG. 10, which depicts a device 10 having four light sources operationally configured to emit light (see Arrows X₁-X₄) in a plurality of directions out from the housing 12. In exemplary operation, including a device 10 for illuminating a box like enclosure, the device 10 may include a light source array operationally configured to emit light toward one or more locations within an enclosure when the cover to the enclosure is opened or removed (see the example of FIG. 12). With attention to FIG. 13, the device 10 is suitably secured to the inner surface of the enclosure so that the cover of the enclosure can contact the actuator member 17 and direct the actuator member 17 to a depressed position when the cover is shut or closed. In this way, no power is wasted illuminating the enclosure at a time when illumination is not necessary. In another example, where low light environments are anticipated, a plurality of devices 10 may be employed to provide a desired amount of light to one or more particular areas.

For the purposes of this application, suitable light sources 18 may include, but are not necessarily limited to LEDs, incandescent bulbs, halogen lamps, and combinations thereof. In one particularly advantageous embodiment, the one or more light sources 18 include LEDs electrically connected to the PCB 20 as shown in FIG. 4. As understood by the skilled artisan, LEDs 18 are available across the visible, ultraviolet, and infrared wavelengths and one or more of the same may be desired for a given operation of the device 10. Any color or color combination may also be employed as desired, e.g., white, red, orange, yellow, green, light blue, blue, dark blue. For example, white light-emitting diodes are often employed for emitting white light. Although the device 10 may be built to scale, suitable devices 10 may include LEDs 18 having sizes ranging from about 2.0 mm to about 10.0 mm in diameter and a height ranging from about 3.0 mm to about 7.0 mm.

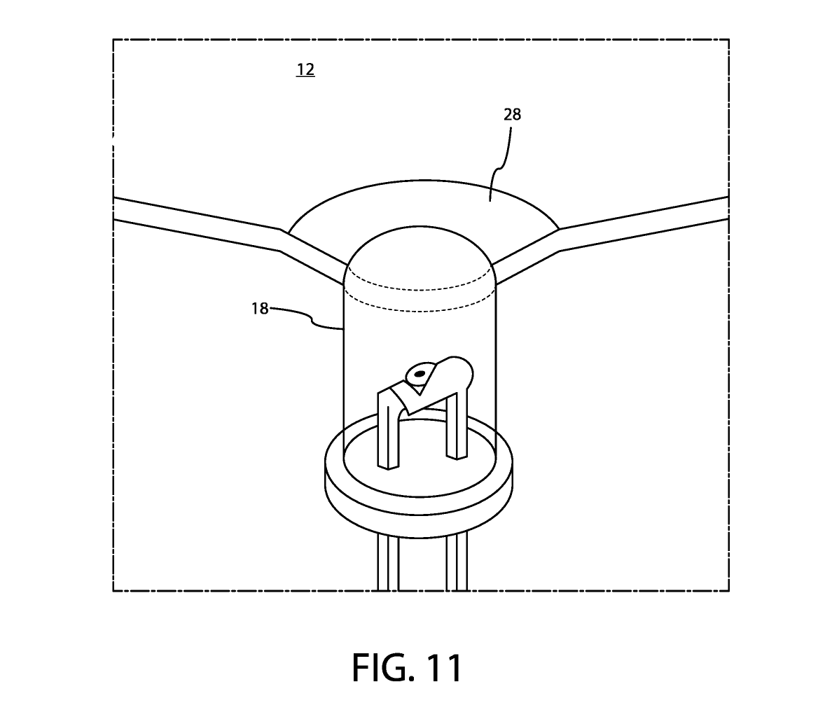

As understood by persons of ordinary skill in the art, LEDs are typically provided with an epoxy case or lens having a dome like form. In one suitable embodiment, the openings 28 provided for the LEDs 18 include a diameter (or width) less than the diameter (or width) of the LEDs whereby the LED case abuts the perimeter of the corresponding opening 28. One suitable embodiment is shown in the exemplary illustration of FIG. 11 where the housing 12 includes a recessed opening 28 and an LED 18 in abutment thereto where the distal portion of the LED 18 is set below the outer surface of the housing 12. In one embodiment, the LED 18 may abut the perimeter of the corresponding opening 28 in a manner effective to form a seal there between. In another embodiment, a gasket, O-ring or other sealing member may be incorporated between the LED 18 and a corresponding opening 28 in a manner effective to form a seal at the opening 28. In one embodiment, a gasket, O-ring or other sealing member may be provided as part of the inner surface 32 of the housing 12. In still another embodiment, the opening 28 may be sealed or closed off with a transparent or translucent material allowing for the emission of light from one or more light sources 18 within the housing 12.

Without limiting the invention, a seal may be provided between the LED 18 and the opening 28 via one or more sealants disposed there between effective to form a fluid and/or solids seal of the opening 28 and assist in setting the LED 18 in a static position with the housing 12 during use. Suitable sealants include, but are not necessarily limited to one or more resin materials such as epoxy resin and silicon resin, and plastic bonding adhesives. In one particular embodiment, the sealant at the one or more openings 28 may include a transparent epoxy resin.

The invention will be better understood with reference to the following non-limiting example, which is illustrative only and not intended to limit the present invention to a particular embodiment.

### Example 1

In a first non-limiting example, a device 10 operationally configured to be removably adhered to the inner surface of a tool box 200 for illuminating the tool box 200 (see FIG. 14) is provided having the following characteristics:

| | |
|---|---|
| Housing | Length - about 62.7 mm |
| 12: | Width - about 32.0 mm |
| | Thickness - about 11.5 mm |
| | Material of Construction - injection molded ABS |
| Cover | Length - about 19.8 mm |
| 19: | Diameter - about 5.6 mm |
| | Diameter of each Dual Collar Member - about 6.6 mm |
| | Material of Construction - injection molded ABS |
| Battery | Coin type Lithium |
| 15: | Quantity - Two |
| | Diameter - about 20.0 mm |
| | Height - about 3.2 mm |
| Light Source | Light Emitting Diodes |
| 18: | Quantity - Two |
| | Diameter - about 5.80 mm |
| | Height - about 4.80 mm |
| Electrical Switch | Length - about 12.7 mm |
| 16: | Width - about 5.70 mm |
| | Thickness - about 6.60 mm |

Adhesive material sealing the housing 12 and the openings 28: Transparent Epoxy Resin

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

We claim:

1. An illumination device comprising:
a housing defined by an outer surface, an inner surface and a plurality of openings there through; and
electronic components for forming a circuit, the electronic components including at least a power supply, an electrical switch assembly and one or more light sources, the electronic components being mounted to a printed circuit board within the housing;
wherein the electrical switch assembly is operationally configured to mate with a first opening of the housing in a manner effective to form seals about the first opening on both the outer surface and the inner surface of the housing according to an on/off position of the one or more light sources.

2. The illumination device of claim 1 wherein the electrical switch assembly includes an actuator member and a cover for the actuator member.

3. The illumination device of claim 1 wherein the electrical switch assembly includes a spring biased actuator member and a cover for the actuator member, the cover being defined by first and second sealing members, the first sealing member being located outside of the housing and the second sealing member located inside of the housing, the first and second sealing members being movable relative to the housing according to the on/off position.

4. The illumination device of claim 3 wherein the second sealing member is operationally configured to form a seal about the first opening along the inner surface of the housing when the spring biased actuator member is set at an extended position.

5. The illumination device of claim 3 wherein the first sealing member is operationally configured to form a seal about the first opening along the outer surface of the housing when the spring biased actuator member is set at a depressed position.

6. The illumination device of claim 1 wherein the electrical switch assembly includes an actuator member and a cover for the actuation member, the cover having a first enlarged perimeter surface operationally configured to form a seal about the first opening along the outer surface of the housing and a second enlarged perimeter surface operationally configured to form a seal about the first opening along the inner surface of the housing.

7. The illumination device of claim 2 wherein the cover includes a first collar member located outside of the housing and a second collar member located inside the housing, the first collar member being operationally configured to form a seal about the first opening along the outer surface of the housing when the actuator member is set at a depressed position and the second collar member being operationally configured to form a seal about the first opening along the inner surface of the housing when the actuator member is set at an extended position.

8. The illumination device of claim 7 wherein the electrical switch assembly includes a contact switch assembly operationally configured to dictate the on/off position of the one or more light sources.

9. The illumination device of claim 3 wherein the housing includes at least one opening in the form of a recessed hole operationally configured to abut a light source at a point below the outer surface of the housing.

10. The illumination device of claim 3 wherein the housing is a two part member, each member having side walls with cutout portions effective to form one or more openings when the members are joined together.

11. An illumination device comprising:
a housing defined by an outer surface, an inner surface and a plurality of openings there through;
a circuit formed of electronic components on a circuit substrate, the electronic components including a power source, a contact switch assembly in communication with the power source, the contact switch assembly having an actuator member and a removable cover for the actuator member disposed through a first opening of the housing, and one or more light sources in communication with the power source, the one or more light sources being located at the other openings of the housing;
wherein the removable cover is operationally configured to seal the first opening along the outer surface of the housing when the actuator member is set at a first position and operationally configured to seal the first opening along the inner surface of the housing when the actuator member is set at a second position.

12. The illumination device of claim 11 further including an attachment member for securing the illumination device to a target surface.

13. The illumination device of claim 11 wherein the housing includes an outer surface defined by a non-planar mounting surface including one or more adhesive materials.

14. The illumination device of claim 11 wherein the removable cover includes a first collar member located outside of the housing and a second collar member located within the housing.

15. The illumination device of claim 14 wherein the linear switch assembly includes a biasing member operationally configured to bias the second collar member against the inner surface of the housing.

16. A method for illuminating a cover bearing container, the method comprising:
determining the size of the container and the one or more locations within the container to illuminate when the container cover is in an open position;
providing an illumination device including (1) a housing defined by an outer surface, an inner surface and a plurality of openings there through; and (2) electronic components for forming a circuit, the electronic components including at least a power supply, an electrical switch assembly disposed through a first opening of the housing and one or more light sources mated with other openings of the housing, the electronic components being mounted to a printed circuit board within the housing and the electrical switch assembly being operationally configured to form a seal about the first opening along the outer surface of the housing when the one or more light sources are set at an OFF position and operationally configured to form a seal about the first opening along the inner surface of the housing when the one or more light sources are set an ON position;
adhering the illumination device to an inner surface of the container via an attachment member in a manner effective for the container cover to contact the electrical switch assembly when the container cover is set to a closed position.
